(19) United States
(12) Patent Application Publication
(10) Pub. No.: US 2006/0160617 A1
(43) Pub. Date: Jul. 20, 2006

(54) Gaming and interactive application

(76) Inventors: Justin Hansen, Halesite, NY (US); Avi Outmezguine, Brooklyn, NY (US)

Correspondence Address: SCANBUY, INC., 54 WEST 39TH STREET, FOURTH FLOOR, NEW YORK, NY, 10018, US

(21) Appl. No.: 11/035,442

(22) Filed: Jan. 14, 2005

(51) Int. Cl. A63F 13/00

(52) U.S. Cl. 463/36

(57) ABSTRACT

The present invention enables the translation of data from barcodes to be utilized for the purpose of interacting with a game or other application after being read by the mobile device camera (optical barcode reading). The user can use their camera equipped device to read a barcode which contains some data that enables them to interact with their application or game. This input method speeds up game play and application use as compared to the traditional method of manual key entry of the data. The user can launch their application and then use the included ability to read a barcode with their camera on the mobile device being used. The decoded data is then used by the system to perform the appropriate tasks that can be pre-determined to be triggered by that code. This method of interactivity with the application enhances the user experience and enables them to have a synchronous method of play and usage of the application or game.

### PARENT CASE TEXT

This application claims the benefit of provisional application No. 60/534,992 filed Jan. 9, 2004.

### FIELD OF THE INVENTION

The present invention relates generally to the field of gaming systems and interactive technology which utilizes barcode based technologies to facilitate game play and interaction. More specifically, the present invention describes a system which utilizes the optical barcode scanning capabilities of mobile devices to enhance game play.

### BACKGROUND OF THE INVENTION

There currently exist many methods of input in interactive mobile use and game play. Entering information via key press or transfer by means such as Infrared or cable connection provides users of a game or other interactive application the ability to change, modify or enhance their playing experience. Input can be for interaction with the game itself or through the application with another user.

Interaction through game play or some other application provides users with the ability to relate and work together in the scope of the application or game they are using. The game or application is responsible for detecting the input means and converting that to usable information within the game or application context. The input means is generally something the user has to manually enter in order to interact with their application. The sequence or meaning of this entry can be pre-determined by the designer of the application. The speed of entry is an important factor which impacts the application experience of the user.

Based on the inherent speed and error issues related to the aforementioned existing input methods, there exists a need for a clear, reliable and fast way to enter data in order to facilitate a way to communicate between the user and application and application to application.

### SUMMARY OF THE INVENTION

The present invention is a method of game play or interactivity that allows devices to capture data utilizing the optical barcode scanning capabilities of mobile devices to enhance user experience and game play. The system can be used to interface with mobile gaming systems, applications that provide interactive functionality and community communication applications utilizing input mechanisms to alter or enhance application (game) play.

In use, the user first accesses the application and the optical barcode reading capability is built-in to the application or has an interface to access the handset's built-in optical barcode reading capability. Upon launching this capability, the user can read a barcode using their camera equipped mobile device and the application will respond by using the data from the code as if it was manually entered to enhance game or interactive play.

An application of this for a game is as follows below. The invention allows a user with a camera or scanner equipped cell phone or personal digital assistant (“PDA”) to participate in a game. Two people with camera or scanner equipped phones or PDAs each scan any barcode that they can find. The barcode is then decoded utilizing optical recognition decoding technology (ScanZoom) or conventional decoding technology (if the barcode was acquired utilizing a laser-based scanner). Based on the value of this barcode, the ScanAttack gaming system creates a unique monster or character.

Once each user has created a monster or character, the users can battle their monsters or characters utilizing a variety of different wireless protocols (e.g., Bluetooth, infrared, WAP, etc.). This means that those playing the game wouldn't need to be near one another and could be across the globe while playing. At the end of the battle, the results could be sent to a server that keeps a record of the standings in the game and the battle statistics such as wins and losses that could be checked from the phone or home computer.

The invention will hold true for the following:
Allows users of mobile phones and PDAs having different operating system (e.g., Palm OS, Symbian OS, SmartPhone, Windows CE, etc.) to participate in the same game.
All battle results are stored on a central server so a user's statistics are not lost if the users' cell phone/PDA breaks or is misplaced. This also allows a user to check statistics at any time and location from a mobile phone, PDA, or PC.
Allows for a virtually unlimited amount of monsters and characters to be created since the characteristics of the created being only depend upon the scanned barcode.
No data entry is required to battle another user with ScanAttack.
There are no additional programs to download besides the decoding software in order to participate in the ScanAttack interactive gaming system.

### DETAILED DESCRIPTION OF THE PREFERRED EMBODIMENT(S)

The following presents a detailed description of a preferred embodiment (as well as some alternative embodiments) of the present invention. However, it should be apparent to one skilled in the art that the described embodiment may be modified in form and content to be optimized for a wide variety of situations.

Optical barcode scanners, such as are disclosed in co-pending U.S. patent application Ser. No. 10/757,095 entitled “System and method for decoding and analyzing barcodes using a mobile device” and U.S. patent application Ser. No. 10/796,153 entitled “System and method for decoding barcodes using digital imaging techniques,” have the advantage that their decoding is controlled by software. Thus, optical barcode scanners can be programmed to decode almost any type of barcode and can be updated to decode newer barcode formats. Some examples of commonly used barcode types include UPC-A, UPC-E, ISBN, RSS-14, RSS-14E, RSS-14L, Interleaved 2 of 5, EAN/JAN-8, EAN/JAN-13, Code 3, Code 39 Full ASCII, Code 128, PDF417, QR Code, and Data Matrix.

We claim:

1. A system for gaming comprising:
a gaming device;
a barcode scanner, wherein said barcode scanner is attached to said gaming device;
at least one barcode, wherein said barcode is scanned by said barcode scanner and utilized by said gaming device to create a monster based on the characteristics of said barcode; and
a software application located on said gaming device which allows a user to utilize said monsters to compete in battles against other users and additional monsters created by said gaming device.

2. A system for gaming according to claim 1, wherein said gaming device is capable of communicating with additional gaming devices via a wireless connection.

3. A system for gaming according to claim 1, wherein said gaming device is at least one from the list comprising of, but not limited to, a smart phone, a PDA, a Palm device, a cellular telephone, and a camera phone.
